(19) United States
(12) Patent Application Publication
(10) Pub. No.: US 2008/0011184 A1
(43) Pub. Date: Jan. 17, 2008

(54) Switching electromagnetic moving system

(75) Inventors: Edward Lopatinsky, San Diego, CA (US); Lev Fedoseyev, El Cajon, CA (US); Daniel Schaefer, Kanarravile, UT (US)

Correspondence Address: Edward Lopatinsky, SUITE 307, 5450 COMPLEX ST., SAN DIEGO, CA, 92123, US

(73) Assignee: Industrial Design Laboratories Inc.

(21) Appl. No.: 11/799,203

(22) Filed: May 1, 2007

Related U.S. Application Data
(60) Provisional application No. 60/796,733, filed on May 2, 2006.

(51) Int. Cl. B60L 13/03; B60L 13/06

(52) U.S. Cl. 104/282

(57) ABSTRACT

A switching electromagnetic moving system is comprised of at least one track and at least one moving body located on the track. The track is comprised of a power buss, at least two track sections and a controller. Each track section has a contact surface and comprises electrically connected coil windings spaced apart in a series way to form a multi-phase linear stator. Each track section has a switch and at least one sensor to detect the position of the moving body on the track. For each track section the sensor of the preceding track section relative to the direction of travel of the moving body controls the switch to power on and the sensor of the subsequent track section controls the switch to power off.

### FIELD OF THE INVENTION

The present invention relates generally to electromagnetic systems for moving mechanical bodies along predefined paths. More particularly, the present invention relates to toy and/or entertainment systems, and all subsystems in which it is useful to controllably move an object upon a surface. The present invention is particularly, but not exclusively, useful for systems that relate to toy motion devices such as vehicles.

### BACKGROUND OF THE INVENTION

There are numerous designs of electromagnetic motion control systems executed as miniature toy railways that include a track and at least one vehicle located on said track.

There are known systems of this type, for example, U.S. Pat. No 4,861,306 “Toy Cog Railway” and U.S. Pat. No. 6,648,724 “Toy Railway Liquid Transfer Facility”, that include the track (platform, chassis) driven by an engine and vehicle mounted on said track.

Another type of system, for example, U.S. Pat. No. 3,729,866 “Toy Railway Vehicle and Switching Section”, is comprised of a battery powered vehicle with an electric motor.

The most widely known electromagnetic moving system in the toy industry, as applied to miniature toy railway systems, includes a track comprised of at least two conductive bands that are connected to an electrical supply from which the electric motor of said vehicle can take power by means of brushes or sliding conductive contacts,—see, for example, U.S. Pat. No. 4,217,727 “Miniature Monorail System”.

The main problem of all such known systems is that it is difficult to generate reliable high speed motion of such vehicles because of the absence of attraction between the vehicle and the track, especially at higher speed on turns, and also when the track follows a vertical or nearly vertical path as in a vertical ring or spiral. Even when track sections are configured horizontally an object made to travel at high speed can lose stability and move from the track due to centrifugal and other forces. So, known electromagnetic moving systems must either be speed limited or include some special means to provide reliable attraction between the driven vehicle and the track or mechanical guide by the track. In some cases attraction is achieved between magnets on the bottom of the vehicle and a track made of magnetic conductive (attractive) material. But these means in known systems also add resistance to motion, or drag, to the moving vehicle which therefore require much more power to achieve motion. Most such toys use conductive brushes to provide electrical contact with the electric power source. Some toys use batteries that do not require brushes, in which case they operate uncontrolled, or achieve control through wires or via a wireless radio or infra-red connection, but in such cases have limited operating time due to battery life.

The problems mentioned above were overcome according to the published U.S. patent application Ser. No. 11/176,172 filed Jul. 7, 2005 by the same assignee. But that invention does not employ a method of selectively switching drive current to sections of track allowing the controller to operate longer lengths of track without a significant increase in power.

Therefore, it would be generally desirable to provide an electromagnetic moving system that offers further improvements to the above mentioned invention, including a means by which sections of the track can be selectively powered.

### SUMMARY OF THE INVENTION

According to the present invention a switching electromagnetic moving system is comprised of at least one track and at least one moving body placed upon the track. The general idea of the claimed invention is that it provides a method to selectively allocate current to track sections, thus allowing the controller to operate longer lengths of track without a significant increase in system power requirements.

In order to achieve these objectives, according to the present invention, the track is comprised of a power buss, at least two track sections and a controller. Each of the track sections has an insulated upper contact surface under which are electrically connected coil windings spaced apart in a series way along the track section, forming a multi-phase linear stator. Said stator is executed as at least a 3-phase multi-phase linear stator. The track sections are electrically connected in parallel with the power buss. Each coil winding is located on a plane that substantially coincides with the insulated contact surface and has a magnetic axis substantially perpendicular to that contact surface. Each track section is connected to the power buss through a switch, and includes at least one sensor to detect the position of the moving body on the track.

The sensor of each track section controls the switch of the subsequent track section relative to the direction of the moving body, thus powering the linear stator of the subsequent track section on. And, the sensor of each track section controls the switch of the preceding track section respect to the direction of the moving body displacement to power the linear stator of the preceding track section off.

The moving body placed upon the contact surface is comprised of at least one magnetized object with its magnetic axis(es) substantially perpendicular to the contact surface thus causing interaction with the linear stator when it is powered, creating a force tending to propel the moving body along the track in the manner of a linear motor. The magnetized object may be made as at least one permanent magnet.

The controller is comprised of a voltage regulator and/or a frequency regulator to change the attraction of the moving body to the track section by modulating voltage and therefore current, and/or speed of the moving body by modulating frequency correspondingly. The frequency regulator can be connected with the voltage regulator to change the voltage depending on the frequency changing.

The controller may include a phase sequence commutator thus causing the moving body to selectably move in either of two opposite directions along the track. In this case, the switch of each track section is made as a logic switch electrically connected with the phase sequence commutator. The logic switch powers the linear stator of the same track section on or off depending on the direction of travel of the moving body.

The system can includes at least two identical tracks, two moving bodies, and two controllers correspondingly, with the tracks are spaced apart thus the system is configuring as a race track with independent control of the moving bodies, permitting competition. The track may be executed as a closed loop.

The coil windings of the linear stator may be made as a printed circuit board or as surface mounted coils spaced on a printed circuit board.

The track sections are executed as straight and/or curvilinear track sections and the length of the curvilinear track section are made not more than the length of the linear track sections.

There are two options in respect to the sensors number. According to the first option, each track section has one sensor that is a Hall effect sensor, and it controls switches in preceding and subsequent track sections. According to the second option, for more power economy, each track section has two sensors that are Hall effect sensors placed at each end parts of the track section, and the switch of each track section is controlled in such a way thus the nearest sensor of the preceding track section relative to the direction of travel of the moving body controls the switch to power on, while the nearest sensor of the subsequent track section controls the switch to power off.

The foregoing and other objectives, features and advantages of the invention will be more readily understood upon consideration of the following detailed description of the invention, taken in conjunction with the accompanying drawings.

### BRIEF DESCRIPTION OF THE DRAWINGS

FIG. 1 is a perspective view showing the preferred embodiment of the present invention when the track section has one sensor;

FIG. 1A is a principal scheme describing the preferred embodiment of the present invention according to FIG. 1;

FIG. 2 is a perspective view showing a variant of the preferred embodiment of the present invention when the track section has two sensors;

FIG. 2A is a principal scheme describing a variant of the preferred embodiment of the present invention according to FIG. 1 when the moving body travels in one direction;

FIG. 2B is a principal scheme describing a variant of the preferred embodiment of the present invention according to FIG. 1 when the moving body travels in the opposite direction in respect to FIG. 2A;

FIG. 3 is a perspective view showing the embodiment of the present invention when the switching electromagnetic moving system is configured as a race track;

FIG. 4 is a principal scheme describing a variant of the preferred embodiment of the present invention according to FIG. 2 when the moving body travels in one direction;

FIG. 4A is a principal scheme describing FIG. 4 when the moving body approaches the next sensor;

FIG. 5 is a principal scheme describing a variant of the preferred embodiment of the present invention according to FIG. 2 when the moving body travels in the opposite direction;

FIG. 5A is a principal scheme describing FIG. 5 when the moving body approaches the next sensor;

FIG. 6 is a perspective view showing a part of the multi-phase linear stator when the coil windings are made as a printed circuit board;

FIG. 6A is a perspective view showing a part of the multi-phase linear stator when the coil windings are made as surface mounted coils spaced on a printed circuit board.

### DETAILED DESCRIPTION OF THE INVENTION

The present invention will be described in detail below with reference to the accompanying drawings.

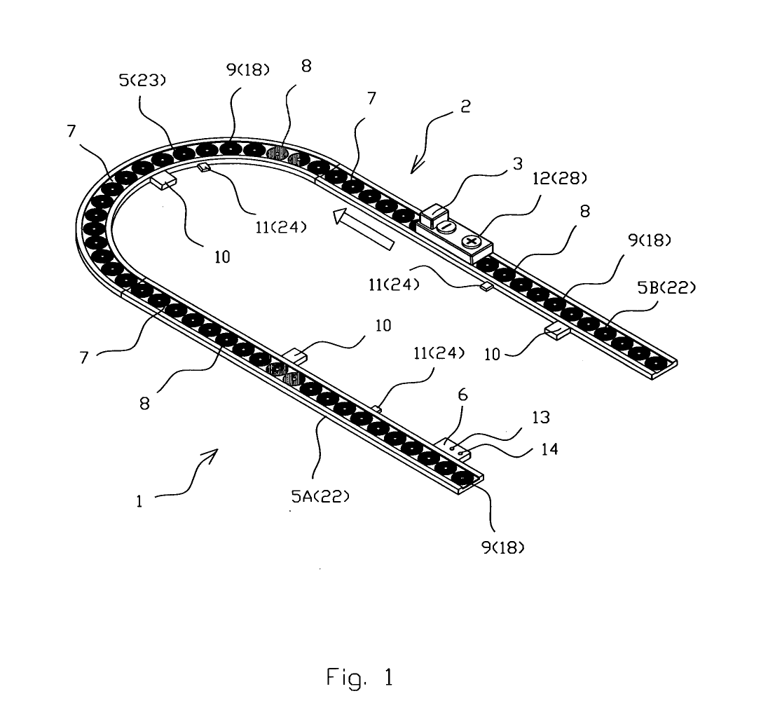

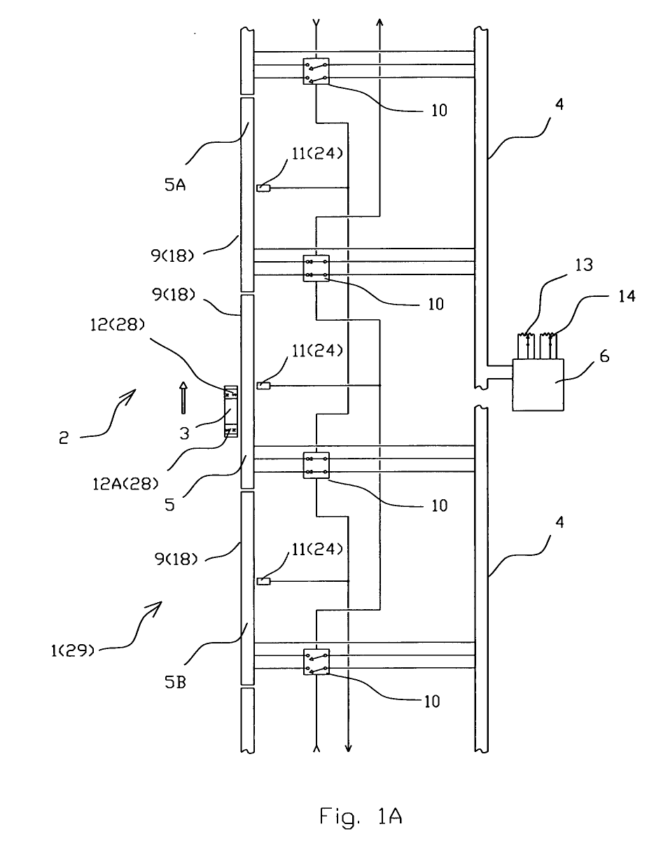

FIGS. 1-6A show embodiments of the present invention.

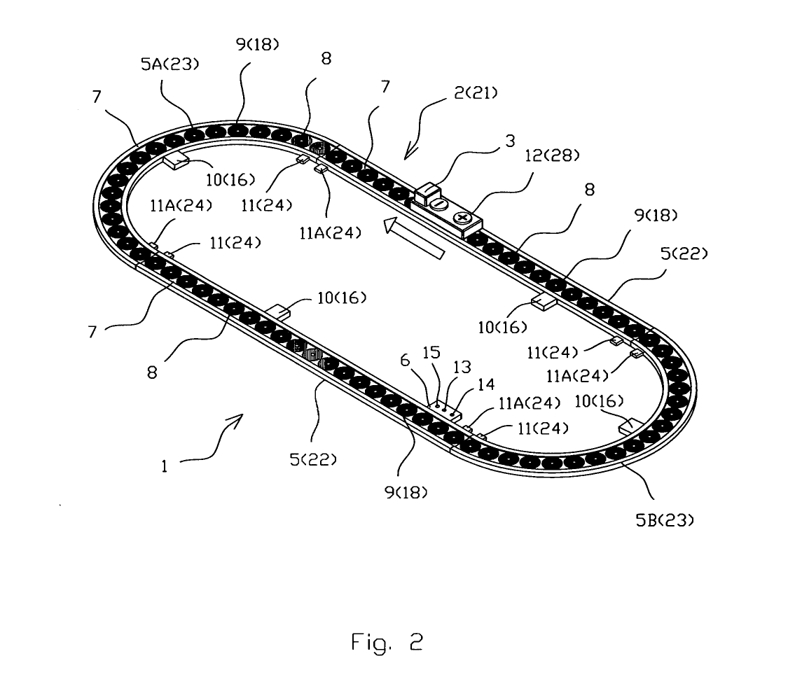

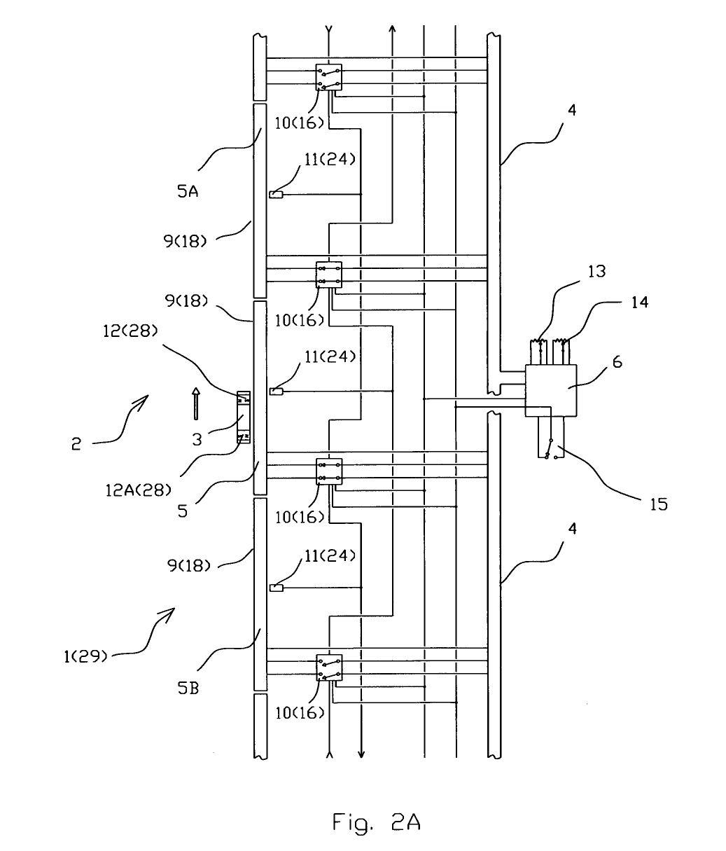

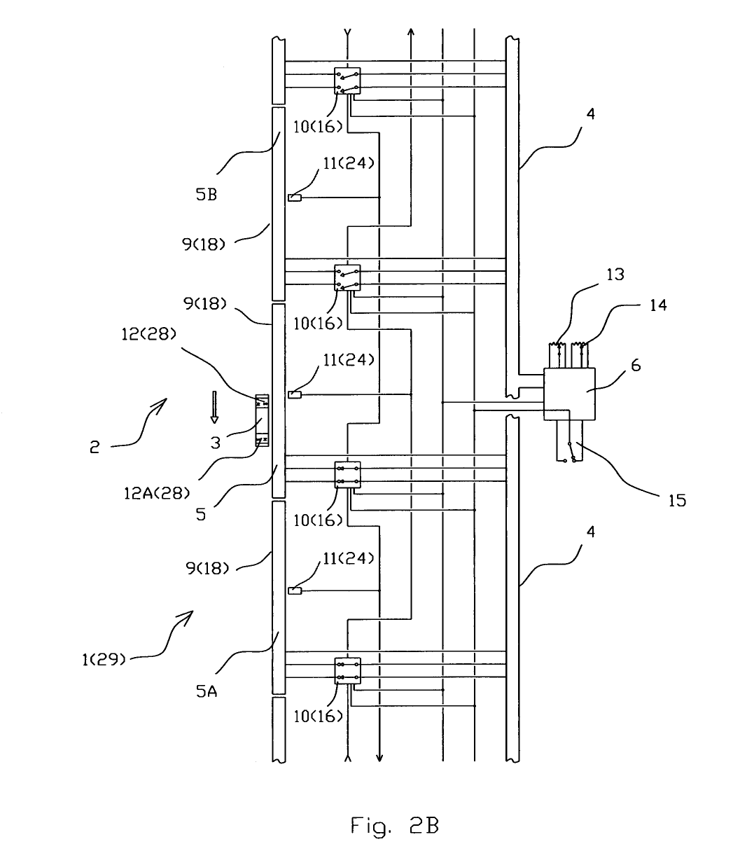

The switching electromagnetic moving system 1 according to the preferred embodiment (FIGS. 1, 1A, 2A and 2B), is comprised of one track 2 and one moving body 3 located on the track 2. The track 2 is comprised of a power buss 4, three track sections 5 and a controller 6. Each of the track sections 5 has a contact surface 7 and is comprised of electrically connected coil windings 8 spaced apart in a series way along the track section 5 and forms a multi-phase linear stator 9. The stator 9 is executed as 3 phase linear stator 9. The track sections 5 are electrically connected in parallel with the power buss 4. Each coil winding 8 is located at a plane substantially coincides with the contact surface 7 and has a magnetic axis substantially perpendicular to the contact surface 7. Each track section 5 has a switch 10 and a sensor 11 that is a Hall effect sensor to detect the moving body position on the track 2.

The sensor 11 of the track section 5 controls the switch 10 of the subsequent track 5A section relative to the direction of the moving body displacement to apply power to the linear stator 9 of the subsequent track 5A section. And, the sensor 11 of the track section 5 controls the switch 10 of the preceding track section 5B relative to the direction of the moving body displacement to remove power from the linear stator 9 of the preceding track section 5B.

The moving body 3 is placed upon the insulated contact surface 7 and is comprised of two magnetized objects 12 and 12A with magnetic axis substantially perpendicular to the contact surface 7 such as to cause interaction with the linear stator 9 when it is powered, thus creating a force tending to propel the moving body 3 along the track 2. The track 2 may be executed as a closed loop 21 (FIG. 2). The track sections 5 are executed as straight 5a and 5B and curvilinear 5 track sections (FIG. 1). The length of the curvilinear track section 5 not more than the length of the linear track sections 5a and 5B.

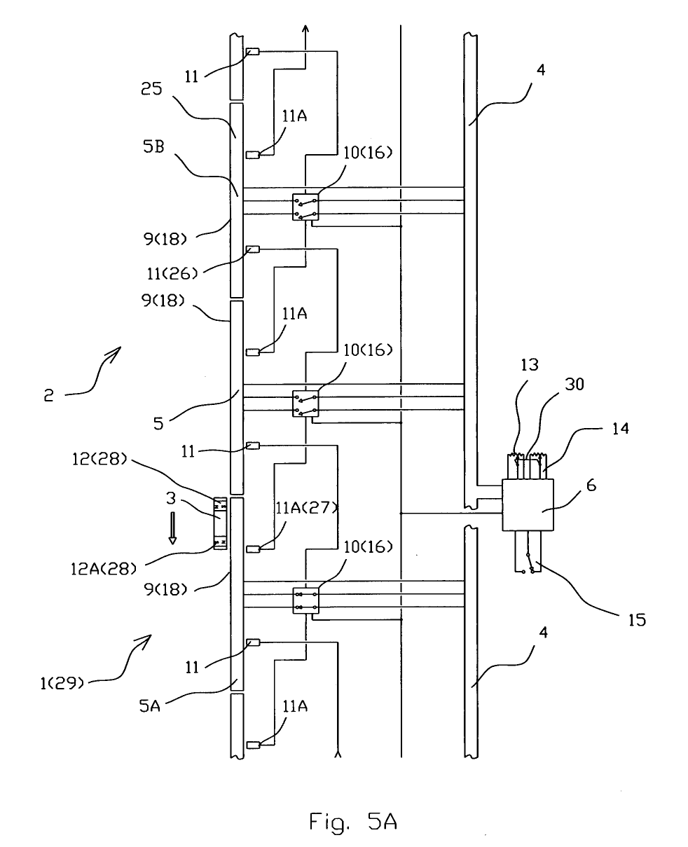

The controller 6 is comprised of a voltage regulator 13 and/or a frequency regulator 14 to change the attraction of the moving body 3 to the track section 5 and/or speed of the moving body 3 correspondingly. The frequency regulator 14 may be connected with the voltage regulator 13 to change the voltage depending on the changed frequency. Such connection may be executed mechanically by the regulator connector 30 (FIGS. 4-5A).

The controller 6 is comprised of a phase sequence commutator 15 (FIGS. 2-2B, 4-5A) thus propelling the moving body 3 in either of two opposite directions along the track 2. Said moving directions are shown by the corresponding arrows on said Figs.

The switch 10 of each track section 5 is made as a logic switch 10 further electrically connected with the phase sequence commutator 15, the logic switch 10 powers the linear stator 9 of the same track section 5 on or off depending on the direction of travel of the moving body 5.

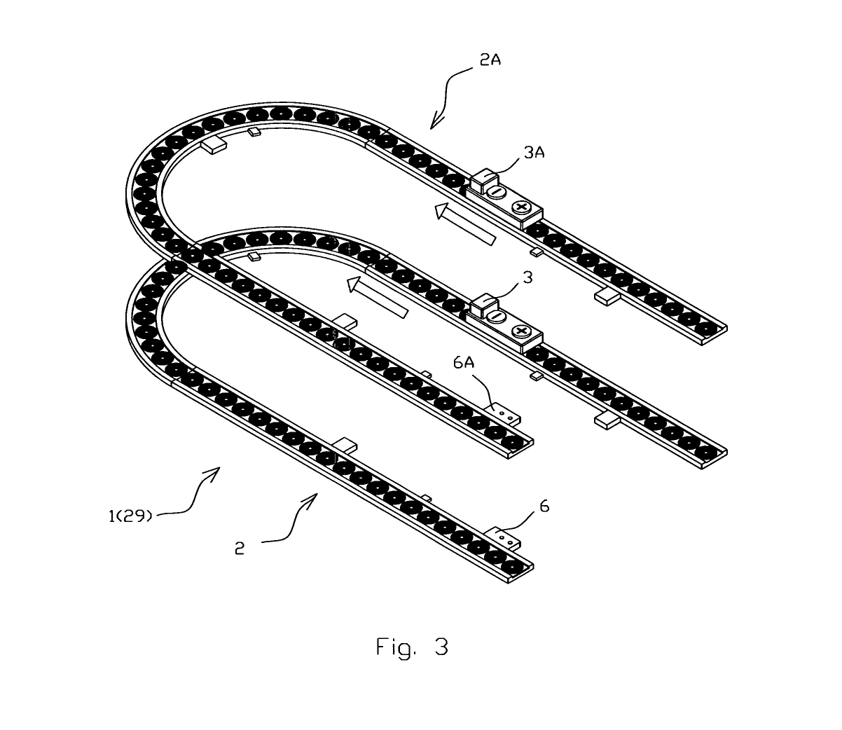

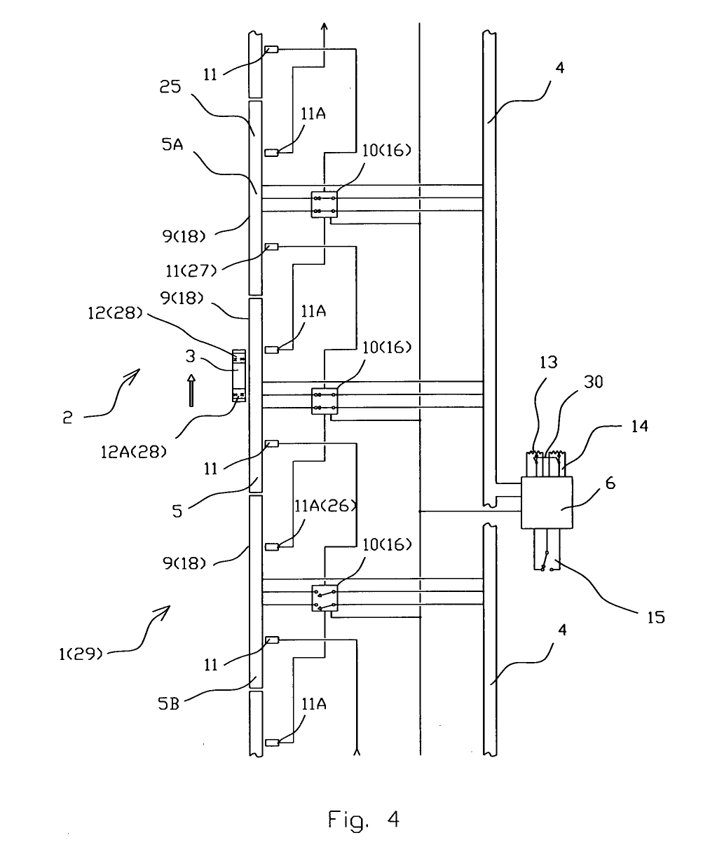

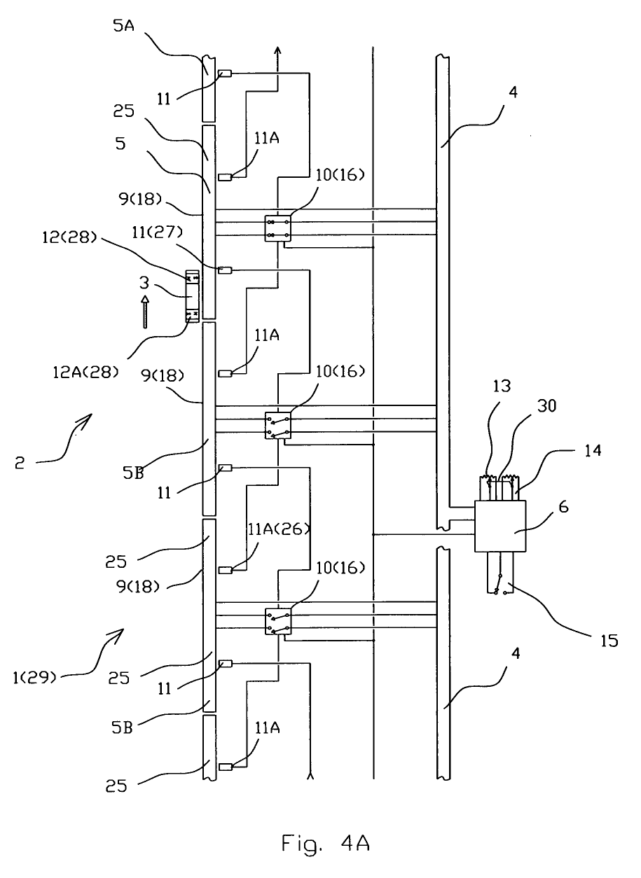

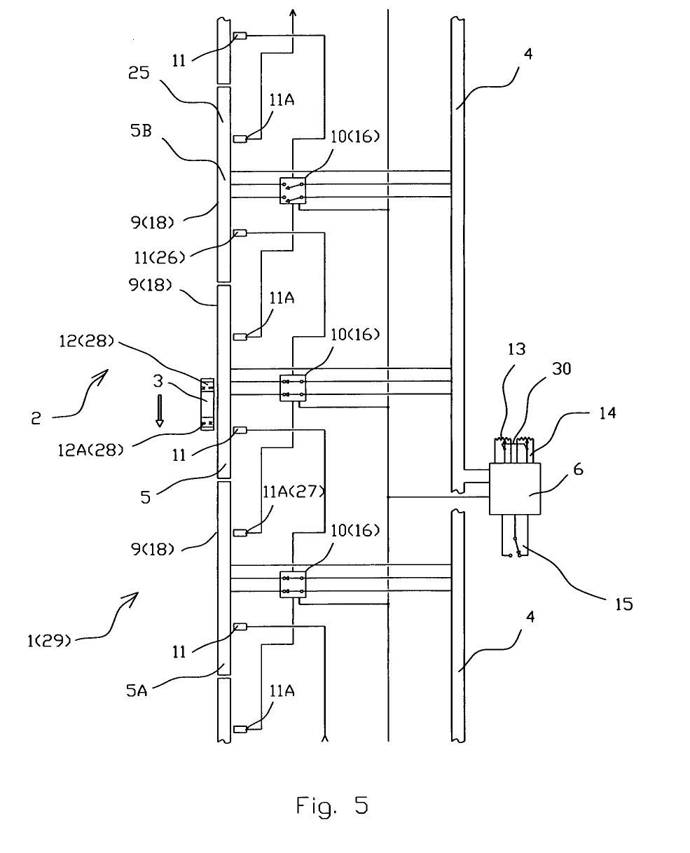

The system 1 may be comprised of two identical tracks 2 and 2A, two moving bodies 3 and 3A, and two controllers 6 and 6A correspondingly (FIG. 3), the tracks 2 and 2A are spaced apart thus the system 1 is configured as a race track 29 with independent control of the moving bodies 3 and 3A, therefore permitting competition.

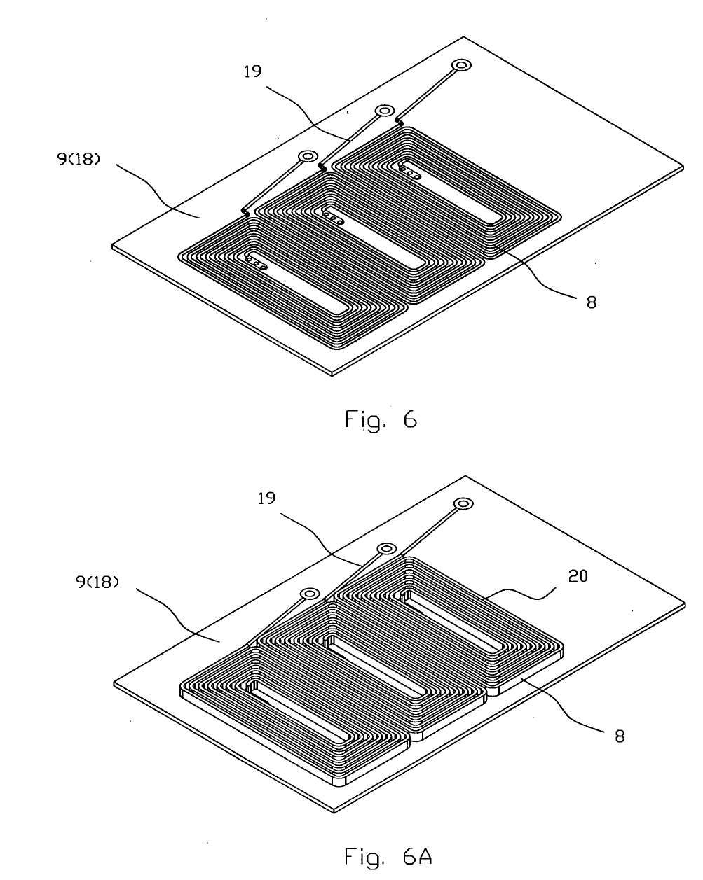

According to the preferred embodiment the coil windings 8 of the linear stator 9 are made as a printed circuit board 19 (FIG. 6) or are made as surface mounted coils 20 spaced on a printed circuit board 19 (FIG. 6A).

According to the second embodiment of the present invention (FIGS. 2, 4-5A) for more power economy each track section 5 has two sensors 11 and 11A that are Hall effect sensors placed at each end parts 25 of the track section 5, and the switch 10 of each track section 5 is controlled in such a way thus the nearest sensor 26 of the preceding track section 5B relative to the direction of travel of the moving body 3 controls the switch 10 to apply power, while the nearest sensor 27 of the subsequent track section 5A controls the switch 10 to disconnect power.

The switching electromagnetic moving system 1 operates as follows. When electrical power is supplied from the power source (not shown) to the coils windings 8 of the track 2 that operate together as the stator 9, alternating electromagnetic fields are created. First, the electrical power is supplied to two adjacent coils windings 8 of the linear stator 9 located on a part of the track 2 where the moving body 3 is located at the commencement of the process. The electromagnetic field created by two adjacent coils windings 8 interacts with a magnetic field created by the permanent magnets 28 of the magnetized object 12, which serve as the moving body 3. As a result, the moving body 3 is propelled along the track 2 to the next segment of coils 8 of the track 2 with two adjacent coils windings 8, where the polarity of electrical power is switched by the controller 6, further propelling the moving body 3, and the moving body 3 continues to move to subsequent coils windings 8, and so on.

While the moving body 3 is traveled along the track 2 in one preliminary defined direction, the permanent magnet 28 is passed through the action zone of the Hall effect sensor 24 of each track section 5 (FIGS. 1 and 1A). FIG. 1A shows the moment when the moving body 3 is approached to the Hall effect sensor 24 of the track section 5. The North Pole of the permanent magnet 28 will activate Hall effect sensor 24 which will create a fixed pulse duration signal. This signal will travel to the switch 10 of the preceding track section 5B and to the switch 10 of the subsequent track section 5A. According to that signals the switch 10 of the preceding track section 5B will remove 3-phase drive power from track section 5B and the switch 10 of the subsequent track section 5A will apply 3-phase power to track section 5A. As the moving body 3 travels forward to the next sensor 24 this process will repeat and will continue in this fashion with only two track sections 5 powered at a time.

FIGS. 2A and 2B illustrate how the system 1 operates when the moving body 3 will travel in either direction along the track 2. The direction of the moving body 3 is defined by the position of the phase sequence commutator 15. In this case the switch 10 of each track section 5 is made as a logic switch 16 electrically connected with the phase sequence commutator 15. When the moving body 3 is traveled in one direction shown by the arrow on FIG. 2A and the moving body 3 is approached to the Hall effect sensor 24 of the track section 5, the North Pole of the permanent magnet 28 will activate Hall effect sensor 24 which will create a fixed pulse duration signal. This signal will travel to the logic switch 16 of the preceding track section 5B and to the logic switch 16 of the subsequent track section 5A. Said logic switches 16 according to both signals from the phase sequence commutator 15 and from the Hall effect sensor 24 of the track section 5 will operate as follows. The switch 16 of the preceding track section 5B will remove 3-phase drive power from track section 5B and the switch 16 of the subsequent track section 5A will apply 3-phase power to track section 5A. As the moving body 3 travels forward to the next sensor 24 this process will repeat and will continue in this fashion with only two track sections 5 powered at a time. When the moving body 3 is traveled along the track 2 in opposite direction illustrated by the arrow on FIG. 2B the system 1 will operate in a similar way.

FIGS. 4-5A illustrate how the system 1 will operate in accordance with the second embodiment of the present invention. Each track section 5 has two sensors 11 and 11A that are the Hall effect sensors and the logic switch 16 electrically connected with the phase sequence commutator 15. When the moving body 3 is traveled in one direction shown by the arrow on FIG. 4 and the moving body 3 is approached to the Hall effect sensor 11A of the track section 5, the North Pole of the permanent magnet 28 will activate said Hall effect sensor 11A which will create a fixed pulse duration signal. This signal will travel to the logic switch 16 of the subsequent track section 5A. Said logic switches 16 according to both signals from the phase sequence commutator 15 and from said Hall effect sensor 11A of the track section 5 will apply 3-phase power to track section 5A. As the moving body 3 travels forward to the next sensor 11 of the subsequent track section 5A (FIG. 4A), the North Pole of the permanent magnet 28 will activate said Hall effect sensor 11 which will create a fixed pulse duration signal. This signal will travel to the logic switch 16 of the track section 5. Said logic switches 16 according to both signals from the phase sequence commutator 15 and from said Hall effect sensor 11 of the track section 5A will remove 3-phase drive power from the track section 5. When the moving body 3 travels forward to the next sensor 11A of the subsequent track section 5A this process will repeat and will continue in this fashion.

If the moving body 3 is traveled along the track 2 in opposite direction illustrated by the arrow on FIGS. 5 and 5A the system 1 will operate in a similar way.

The main effect of the present invention that makes it superior to all known technical solutions in this field is as follows: the system 1 may employ a method of selectively switching drive current to track sections 5 allowing the controller 6 to operate longer lengths of track without a significant increase in power. It also allows the track 2 to operate cooler by allowing a duty cycle for each track section 5 (The more track sections 5 used, the shorter the duty cycle for each track section 5). As an example, using this method of track section switching would allow 30 feet or 300 feet of track 2 to use roughly the same power as three feet of the same track. Two sensors 11 are used on each track section 5 allowing the preceding track section 5B to be turned off earlier than the subsequent track section 5A will be turn on.

The controllers 6 output uses frequency to control the speed the moving body 3 is propelled on the track 2. The higher the frequency the faster the moving body 3 travels. This may be augmented by adjusting the output voltage of the frequency wave. A lower voltage allows for a smoother more efficient slow speed operation. At higher frequencies the voltage is increased to help maintain the moving body 3 lock with the track 2 drive. This allows the moving body 3 to travel faster and handle curves better.

We claim:

1. A switching electromagnetic moving system comprising at least one track and at least one moving body located on said track, wherein:
(i) said track comprises a power buss, at least two track sections and a controller;
(ii) each of said track sections has a contact surface and comprises electrically connected coil windings spaced apart in a series way along said track section to form a multi-phase linear stator;
(iii) said track sections are electrically connected in parallel with said power buss;
(iv) each coil winding is located on a plane that substantially coincides with said contact surface and has a magnetic axis substantially perpendicular to said contact surface;
(v) each track section has a switch and at least one sensor to detect the moving body position on said track;
(vi) said sensor of each track section controls the switch of the subsequent track section relative to the direction of the moving body displacement to apply power to the linear stator of said subsequent track section;
(vii) said sensor of each track section controls the switch of the preceding track section in respect to the direction of the moving body displacement to remove power from the linear stator of said preceding track section;
(viii) said moving body is placed upon said contact surface and comprises at least one magnetized object with magnetic axis substantially perpendicular to said contact surface such as to cause interaction with the linear stator when it is powered, thus creating a force tending to propel said moving body along said track.

2. The system as claimed in claim 1, wherein said controller comprises a voltage regulator and/or a frequency regulator to change the attraction of said moving body to said track section and/or speed of said moving body correspondingly.

3. The system as claimed in claim 2, wherein said frequency regulator is connected with said voltage regulator to change the voltage depending on the selected frequency.

4. The system as claimed in claim 1, wherein said controller comprises a phase sequence commutator thus enabling said moving body to travel in either of two opposite directions along said track.

5. The system as claimed in claim 4, wherein said switch of each track section is made as a logic switch further electrically connected with said phase sequence commutator, said logic switch provides to power or de-power said linear stator of the same track section depending on the direction of travel of said moving body.

6. The system as claimed in claim 1, wherein said system is comprised of at least two identical tracks, two moving bodies, and two controllers correspondingly, and said tracks are spaced apart thus configuring said system as a race track with independent control of the moving bodies and permitting competition.

7. The system as claimed in claim 1, wherein said linear stator is executed as at least a 3 phase linear stator.

8. The system as claimed in claim 1, wherein said coil windings of said linear stator are made as a printed circuit board.

9. The system as claimed in claim 1, wherein said coil windings are made as surface mounted coils spaced on a printed circuit board.

10. The system as claimed in claim 1, wherein said track is executed as a closed loop.

11. The system as claimed in claim 1, wherein said track sections are executed as straight and/or curvilinear track sections.

12. The system as claimed in claim 11, wherein the length of said curvilinear track section is not more than the length of said linear track sections.

13. The system as claimed in claim 1, wherein each track section has one sensor that is a Hall effect sensor;

14. The system as claimed in claim 1, wherein each track section has two sensors that are Hall effect sensors placed at each end parts of said track section, and said switch of each track section is controlled in such a way that the nearest sensor of the preceding track section relative to the direction of travel of said moving body controls said switch to power on, while the nearest sensor of the subsequent track section controls said switch to power off.

15. The system as claimed in claim 1, wherein said magnetized object is made as at least one permanent magnet.
